(19) United States
(12) Patent Application Publication
(10) Pub. No.: US 2026/0318472 A1
(43) Pub. Date: Oct. 15, 2026

(54) Quick-Connect Structure for Tripod Center Column Assembly

(71) Applicant: Coman Photo Equipment (Zhongshan) Co., Ltd., Zhongshan City (CN)

(72) Inventor: Yao Liu, Zhuhai City (CN)

(21) Appl. No.: 19/267,979

(22) Filed: Jul. 14, 2025

(30) Foreign Application Priority Data
Apr. 15, 2025 (CN) 2025207169828

(51) Int. Cl. F16M 11/24; G03B 17/56

(52) U.S. Cl. CPC F16M 11/24; G03B 17/561; F16M 2200/025

(57) ABSTRACT

A quick-connect structure for a tripod center column assembly. The structure comprises a linkage assembly movably disposed on a center column and a locking collar mounted on a mounting head. A toggle assembly is operatively connected to the linkage assembly, and a compression assembly configured for axial movement is arranged on the linkage assembly. The toggle assembly actuates the compression assembly to move axially via the linkage assembly, enabling the compression assembly to form either a locked or unlocked state with the locking collar. The structure facilitates one-touch locking and unlocking through the coordinated motion of the toggle lever and the linkage assembly, thereby improving operational efficiency. Additionally, the cooperative engagement among a locking ball, a tapered locking surface, and a conical cam surface establishes a secure locked state, ensuring firm locking and preventing loosening.

### FIELD OF INVENTION

The present invention relates to photographic tripod systems, and more particularly to a quick-connect structure for a center column assembly of a tripod.

### BACKGROUND OF THE INVENTION

Conventional center column assemblies for photographic tripods typically employ threaded or snap-fit connection mechanisms. Threaded connections, while structurally robust, are time-intensive to operate and prone to wear over time due to repeated engagement and disengagement. Snap-fit connections, which generally rely on the insertion of protrusions into corresponding grooves, are susceptible to cumulative manufacturing tolerances among multiple components. This accumulation of tolerances may introduce radial gaps between the center column and a mounting head component, thereby compromising the stability of the connection and increasing the likelihood of loosening during use.

### SUMMARY OF THE INVENTION

The present invention is directed to addressing at least one of the technical challenges associated with conventional tripod center column designs. To this end, the invention provides a quick-connect structure for a tripod center column assembly.

To overcome the foregoing deficiencies, the present invention adopts the following technical solution.

A quick-connect structure for a tripod center column assembly comprises a linkage assembly movably mounted to a center column and a locking collar disposed on a mounting head. A toggle assembly is operatively coupled to the linkage assembly. A compression assembly, configured for axial movement, is disposed on the linkage assembly. The toggle assembly actuates the compression assembly to move axially via the linkage assembly, thereby selectively establishing a locked or unlocked state between the compression assembly and the locking collar.

In a preferred embodiment, the compression assembly comprises a mounting hub mounted on the linkage assembly. A cylindrical ball support is movably arranged about an outer peripheral surface of the mounting hub. A plurality of locking balls is radially distributed on the cylindrical ball support.

In a further preferred embodiment, an inner wall of the locking collar is formed with a tapered locking surface. A receiving cavity is defined within the cylindrical ball support. A sliding wedge having a conical cam surface is movably disposed within the receiving cavity. The conical cam surface is configured to urge the locking balls radially outward to abut against the tapered locking surface, thereby forming a locked state.

In another preferred embodiment, the linkage assembly comprises a pair of linkage rods symmetrically disposed on the mounting hub. A crossbar is connected between the linkage rods to enable rotational engagement with the toggle assembly.

In another embodiment, a guide chamber is formed within the mounting hub. A guide post, slidably engaged with the guide chamber, is connected to the sliding wedge. A compression spring is wound around the guide post, with opposing ends of the compression spring respectively connected to the sliding wedge and the mounting hub, thereby providing a biasing force.

In yet another embodiment, the center column defines a guide slot configured to accommodate motion of the linkage assembly.

In a further embodiment, the toggle assembly comprises a toggle lever. A left bracket and a right bracket are connected to the toggle lever. The left bracket is pivotally mounted to the linkage assembly, and the right bracket is pivotally mounted to the center column. A limit notch is formed on the center column and is in communication with the guide slot. When the toggle lever is displaced from the limit notch, the toggle lever drives the right bracket to rotate, which in turn actuates the linkage assembly via the left bracket.

### Advantages of the Present Invention

The quick-connect structure for a tripod center column assembly of the present invention enables one-touch locking and unlocking through the cooperative motion of the toggle lever and the linkage assembly, thereby significantly enhancing operational efficiency. Furthermore, the cooperative engagement of the locking ball, tapered locking surface, and conical cam surface ensures a reliable locking state and prevents unintended loosening.

### BRIEF DESCRIPTION OF THE DRAWINGS

The above and/or other features and advantages of the present invention will become more apparent from the following detailed description of the embodiments, taken in conjunction with the accompanying drawings, in which:

FIG. 1 is a first structural schematic view of the quick-connect structure for a tripod center column assembly in accordance with the present invention;

FIG. 2 is a second structural schematic view of the quick-connect structure;

FIG. 3 is a third structural schematic view of the quick-connect structure;

FIG. 4 is a fourth structural schematic view of the quick-connect structure; and

FIG. 5 is a structural schematic view of the mounting head and the locking collar.

### DETAILED DESCRIPTION OF THE PREFERRED EMBODIMENTS

The embodiments of the present invention are described in detail below with reference to the accompanying drawings. The same or similar reference numerals are used throughout the drawings to denote identical or functionally equivalent elements, unless otherwise specified.

The spatial orientations illustrated in the drawings are provided solely for illustrative purposes and do not limit the scope of protection of the present invention. Positional relationships, component counts, or structural configurations depicted in the drawings may be varied, increased, or simplified without departing from the intended scope.

As used in the present specification, the term “connection” and the corresponding depiction of connected components in the drawings may refer to fixed connections, detachable connections, or integral formations. The connection may be direct or may involve one or more intermediary elements. Those skilled in the art will appreciate that connection relationships may be implemented using appropriate methods, such as threaded engagement, riveting, soldering, snap-fitting, or embedding, depending on specific application needs.

Directional terms such as “upper,” “lower,” “left,” “right,” “top,” and “bottom” as used in the specification and drawings are not intended to be limiting and may refer to relative positions or directions. For example, “above” may indicate a position directly above, obliquely above, or generally higher than another component. Similar interpretations apply to other directional terms.

The components of physical form described in the present specification and shown in the drawings may be manufactured from metallic materials, non-metallic materials, or composite materials. Suitable manufacturing techniques include, but are not limited to, stamping, forging, casting, wire cutting, laser cutting, injection molding, CNC milling, 3D printing, and conventional machining. Those skilled in the art may select or combine these materials and techniques as appropriate, considering processing conditions, cost constraints, and required tolerances.

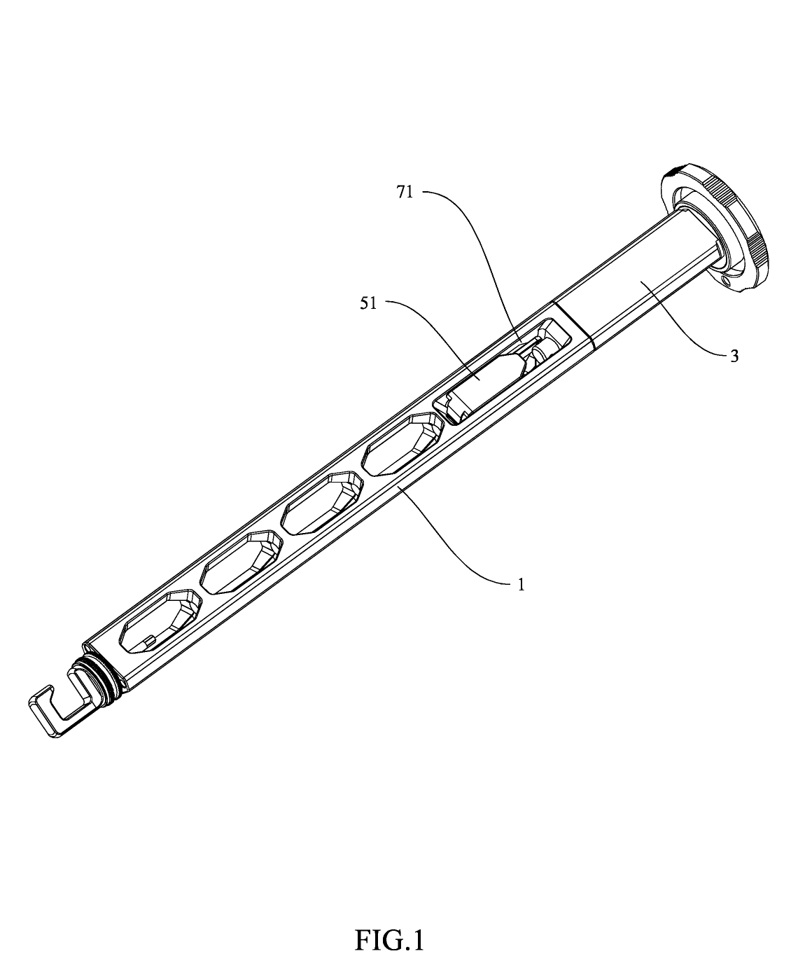

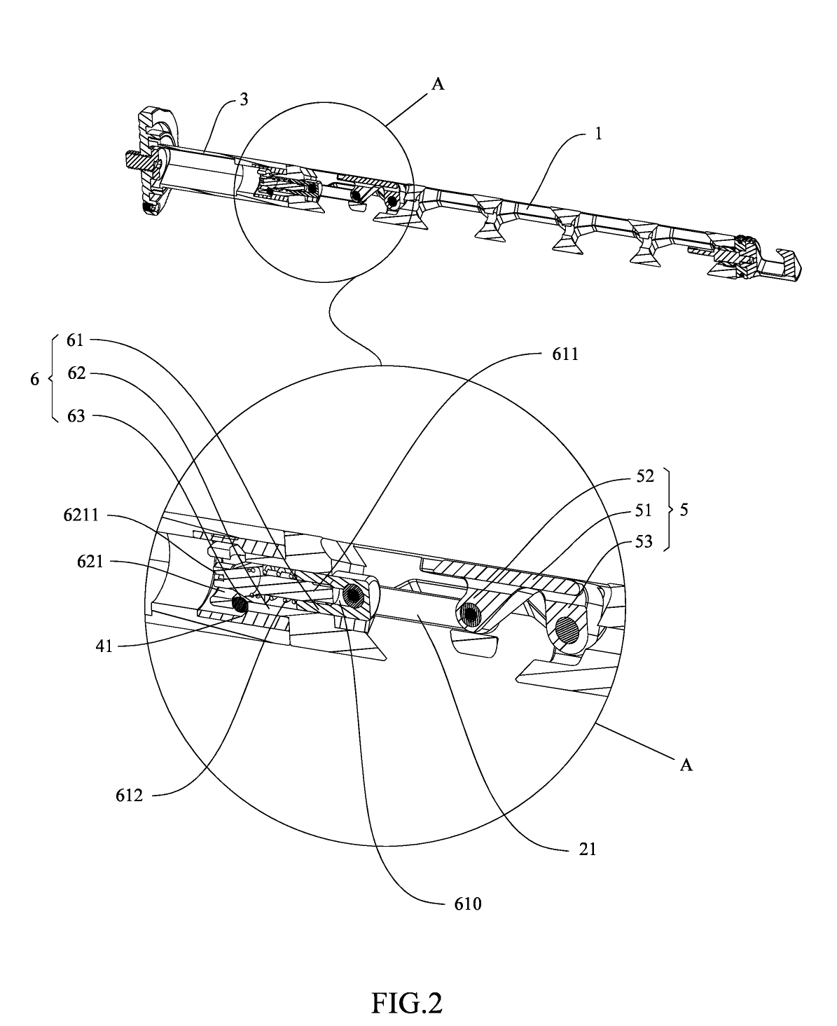

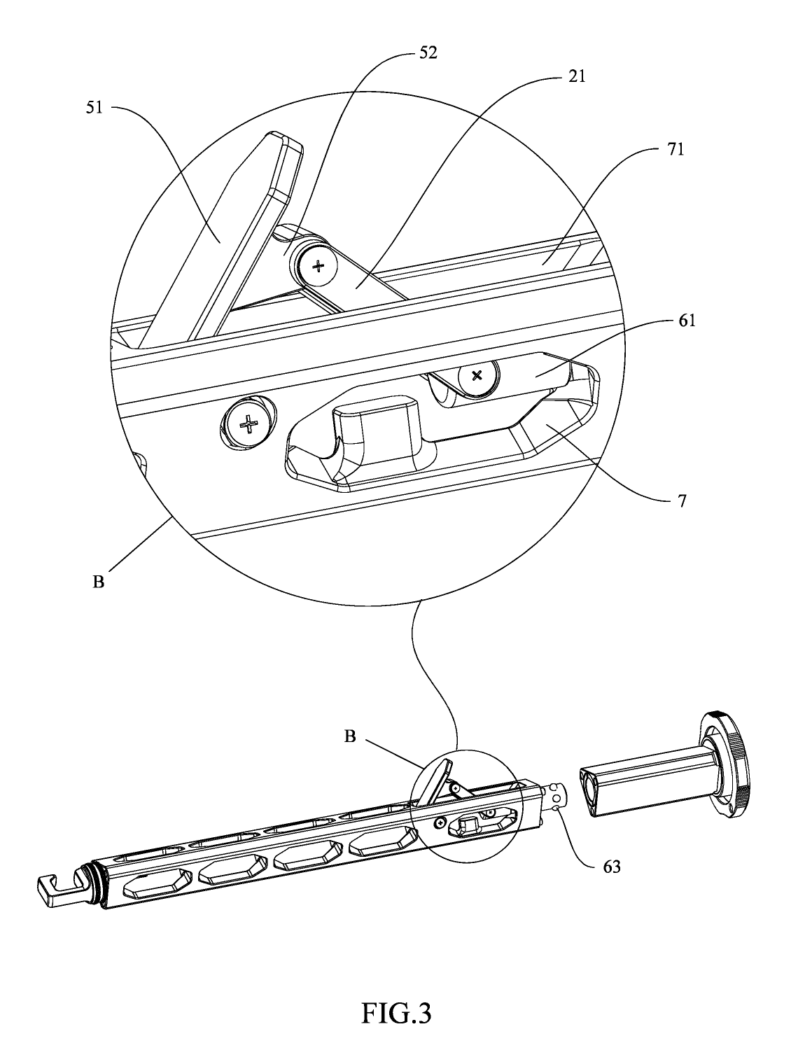

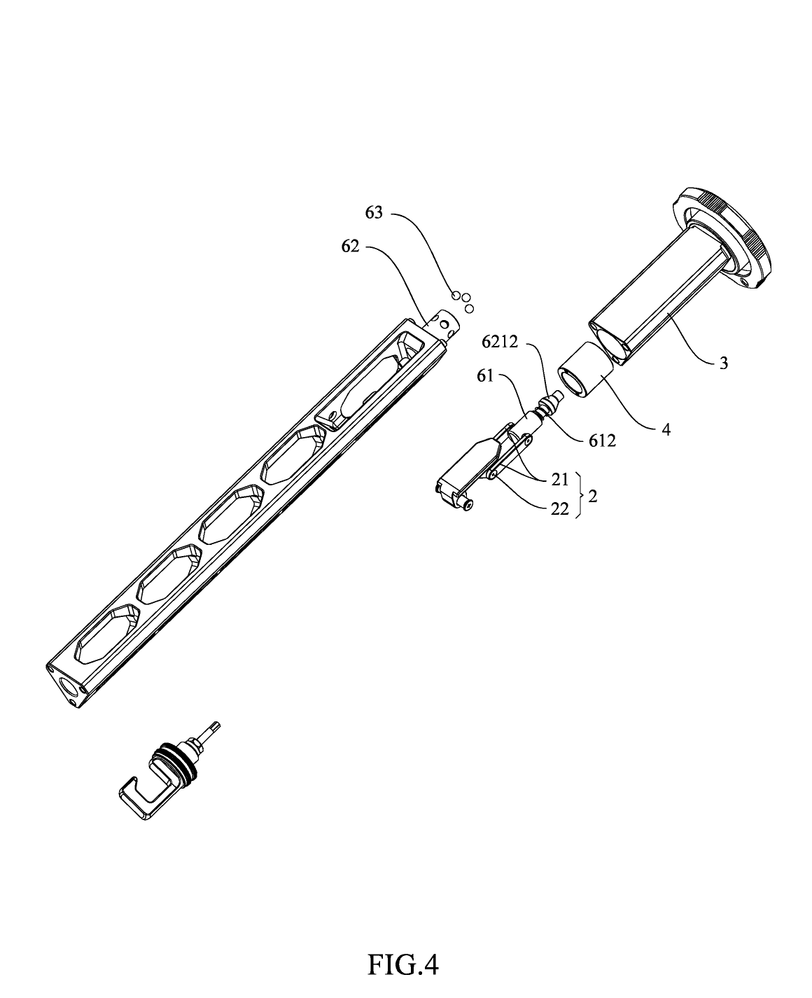

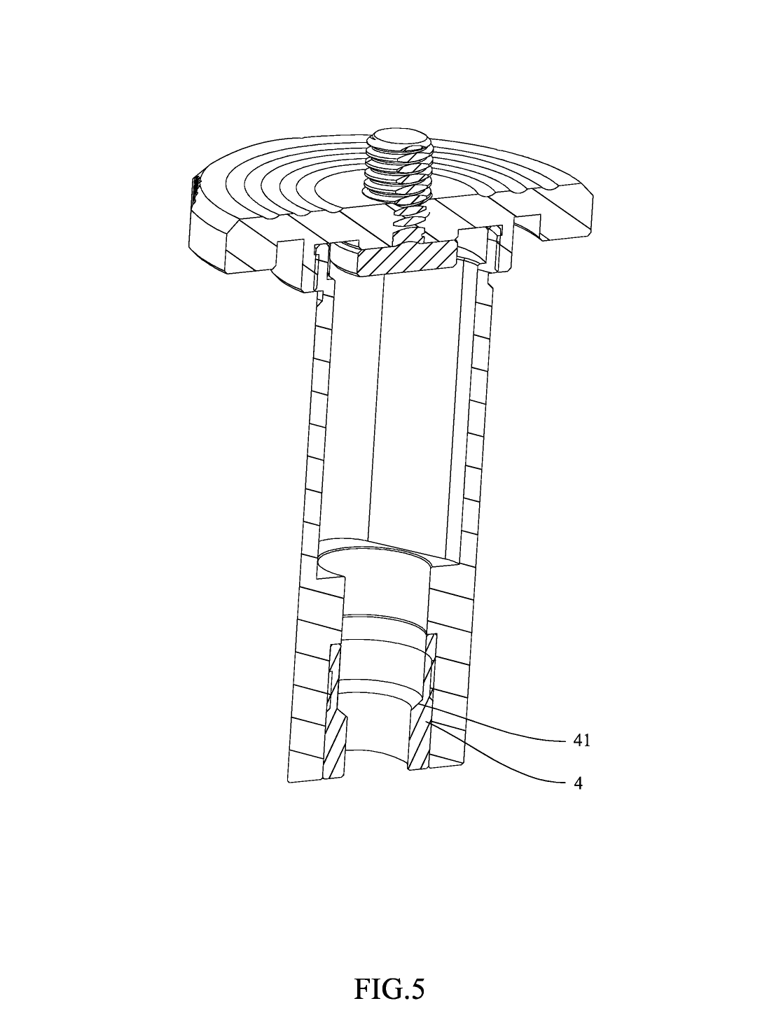

Referring to FIGS. 1-5, a quick-connect structure for a tripod center column assembly comprises a linkage assembly 2 movably disposed within a center column 1, and a locking collar 4 mounted on a mounting head 3. A toggle assembly 5 is operatively connected to the linkage assembly 2. A compression assembly 6, configured for axial movement, is arranged on the linkage assembly 2. The toggle assembly 5 actuates the compression assembly 6 to move axially via the linkage assembly 2, enabling the compression assembly 6 to engage with or disengage from the locking collar 4 to form a locked or unlocked state, respectively.

As illustrated, the compression assembly 6 comprises a mounting hub 61 disposed on the linkage assembly 2. A cylindrical ball support 62 is movably arranged about an outer peripheral surface of the mounting hub 61. A plurality of locking balls 63 are radially distributed on the cylindrical ball support 62.

An inner wall of the locking collar 4 is provided with a tapered locking surface 41. A receiving cavity 621 is defined within the cylindrical ball support 62. A sliding wedge 6211, having a conical cam surface 6212, is slidably disposed within the receiving cavity 621. The conical cam surface 6212 is configured to urge the locking balls 63 radially outward so that they abut tightly against the tapered locking surface 41, thereby facilitating secure locking engagement.

The linkage assembly 2 further comprises a pair of linkage rods 21 symmetrically arranged on the mounting hub 61. A crossbar 22 is connected between the linkage rods 21 and is configured to engage rotatably with the toggle assembly 5.

A guide chamber 610 is formed within the mounting hub 61. A guide post 611 is slidably received within the guide chamber 610 and is connected to the sliding wedge 6211. A compression spring 612 is wound around the guide post 611, with opposite ends of the compression spring 612 respectively fixed to the sliding wedge 6211 and the mounting hub 61.

A guide slot 7 is formed in the center column 1 to accommodate axial movement of the linkage assembly 2.

The toggle assembly 5 comprises a toggle lever 51. A left bracket 52 and a right bracket 53 are connected to the toggle lever 51. The left bracket 52 is pivotally mounted to the linkage assembly 2, while the right bracket 53 is pivotally mounted to the center column 1. A limit notch 71, which communicates with the guide slot 7, is formed in the center column 1. When the toggle lever 51 is displaced from the limit notch 71, it rotates the right bracket 53, which in turn actuates the linkage assembly 2 through the left bracket 52.

### Working Principle of the Present Invention

The working principle of the quick-connect structure for a tripod center column assembly is described as follows.

Initial state: In the initial, unlocked state, the toggle lever 51 is not actuated and remains displaced from the limit notch 71. The compression spring 612 is in its naturally extended configuration. In this state, the locking balls 63 set are not in contact with a locking collar 4, and the center column 1 is free to move relative to a mounting head 3.

Locking process: When the toggle lever 51 is pressed downward, it actuates the compression assembly 6 via the linkage assembly 2, causing the compression assembly 6 to move axially and rapidly engage with the locking collar 4. In one embodiment, the linkage assembly 2 comprises the linkage rods 21 cooperating with the mounting hub 61. The compression assembly 6 includes the compression spring 612, the cylindrical ball support 62, the locking balls 63, and the sliding wedge 6211, illustrating the core design concept of the invention. Upon inserting the cylindrical ball support 62 into the locking collar 4 and pressing the toggle lever 51, the toggle lever 51, pivotally connected to the linkage rods 21, drives the linkage rods 21, which in turn move the sliding wedge 6211 toward the locking collar 4 via the mounting hub 61. The sliding wedge 6211 is slidably positioned within a receiving cavity 621 formed in the cylindrical ball support 62. As the sliding wedge 6211 advances, it pushes one side of the locking balls 63 into tight abutment with the tapered locking surface 41 formed on the inner wall of the locking collar 4. With continued actuation of the toggle lever 51, the sliding wedge 6211 is further driven forward by the linkage rods 21. The conical cam surface 6212, formed on the sliding wedge 6211, progressively urges the locking balls 63 outward against the tapered locking surface 41. At this point, each locking ball 63 is tightly held between the conical cam surface 6212 and the tapered locking surface 41, thereby forming a stable locked state. Once locking is complete, the toggle lever 51 is received within the limit notch 71, thereby maintaining the engagement between the center column 1 and the mounting head 3. In the locked configuration, the sliding wedge 6211 is connected to the guide post 611, which is slidably received within the guide chamber 610 formed in the mounting hub 61. The compression spring 612 is wound around the guide post 611, with opposite ends fixed to the sliding wedge 6211 and the mounting hub 61. The compression spring 612 provides a restoring force that biases the conical cam surface 6212 against the locking balls 63, ensuring sustained locking force.

Unlocking process: To disengage the connection, the toggle lever 51 is pulled in the opposite direction. This movement causes the linkage rods 21 to retract, driving the mounting hub 61 and the sliding wedge 6211 back toward the center column 1. As the sliding wedge 6211 moves rearward, the conical cam surface 6212 is withdrawn from the locking balls 63, thereby releasing the radial pressure against the tapered locking surface 41. Once the center column 1 is extracted, the locking balls 63 are freed from the tapered locking surface 41, allowing the center column 1 and the mounting head 3 to be easily separated.

Based on the above-described structural arrangement, the toggle assembly 5 may be configured such that the toggle lever 51 is connected to both the left bracket 52 and the right bracket 53. The left bracket 52 is pivotally mounted to the linkage assembly 2, while the right bracket 53 is pivotally mounted to the center column 1. The limit notch 71, in communication with the guide slot 7, is formed on the center column 1. When the toggle lever 51 is displaced from the limit notch 71, it rotates the right bracket 53, which in turn drives the linkage assembly 2 via the left bracket 52. When locking the center column 1 to the mounting head 3, the toggle lever 51 is actuated such that it drives the linkage assembly 2 within the guide slot 7 (with the right bracket 53 rotating about the center column 1 and the left bracket 52 actuating the linkage assembly 2 in a swinging motion). Once the toggle lever 51 is received and constrained within the limit notch 71, the center column 1 is securely locked to the mounting head 3.

The quick-connect structure for the photographic tripod center column 1 of the present invention achieves efficient one-touch locking and unlocking by virtue of the coordinated actuation between the toggle lever 51 and the linkage assembly 2. In addition, the cooperative engagement among the locking balls 63, the tapered locking surface 41, and the conical cam surface 6212 establishes a secure locked state that prevents loosening and enhances operational reliability.

Although the present invention has been described in detail with reference to the above embodiments, it will be apparent to those skilled in the art that modifications and variations may be made without departing from the principles and spirit of the invention as defined in the appended claims. Accordingly, the foregoing detailed description is intended for illustrative purposes only and should not be construed as limiting the scope of the invention, which is defined solely by the claims.

What is claimed is:

1. A quick-connect structure for a tripod center column assembly, comprising:
a linkage assembly movably disposed on a center column;
a locking collar disposed on a mounting head;
a toggle assembly operatively coupled to the linkage assembly; and
a compression assembly arranged on the linkage assembly and configured to move axially;
wherein the toggle assembly is configured to actuate the compression assembly to move in an axial direction via the linkage assembly, such that the compression assembly is capable of forming a locked or unlocked state with the locking collar.

2. The quick-connect structure according to claim 1,
wherein the compression assembly comprises a mounting hub disposed on the linkage assembly,
wherein a cylindrical ball support is movably arranged about an outer peripheral surface of the mounting hub, and
wherein a plurality of locking balls is radially distributed on the cylindrical ball support.

3. The quick-connect structure according to claim 2,
wherein an inner wall of the locking collar comprises a tapered locking surface,
wherein a receiving cavity is formed in the cylindrical ball support,
wherein a sliding wedge having a conical cam surface is movably disposed within the receiving cavity, and
wherein the conical cam surface is configured to push the locking balls into tight abutment with the tapered locking surface.

4. The quick-connect structure according to claim 2,
wherein the linkage assembly comprises a pair of linkage rods symmetrically disposed on the mounting hub, and
wherein a crossbar is connected between the pair of linkage rods to provide rotational engagement with the toggle assembly.

5. The quick-connect structure according to claim 3,
wherein a guide chamber is formed within the mounting hub,
wherein a guide post is slidably received within the guide chamber and is connected to the sliding wedge,
wherein a compression spring is wound around the guide post, and
wherein opposite ends of the compression spring are respectively connected to the sliding wedge and the mounting hub.

6. The quick-connect structure according to claim 1, wherein the center column defines a guide slot configured to accommodate movement of the linkage assembly.

7. The quick-connect structure according to claim 6,
wherein the toggle assembly comprises a toggle lever,
wherein a left bracket and a right bracket are connected to the toggle lever,
wherein the left bracket is rotatably mounted to the linkage assembly,
wherein the right bracket is rotatably mounted to the center column,
wherein the center column further defines a limit notch in communication with the guide slot, and
wherein, when the toggle lever is displaced from the limit notch, the toggle lever is configured to rotate the right bracket, thereby driving the linkage assembly to move via the left bracket.
